(19) United States
(12) Patent Application Publication
(10) Pub. No.: US 2020/0373552 A1
(43) Pub. Date: Nov. 26, 2020

(54) LOW TORTUOSITY ELECTRODES AND ELECTROLYTES, AND METHODS OF THEIR MANUFACTURE

(71) Applicant: FISKER, INC., Torrance, CA (US)

(72) Inventors: Fabio ALBANO, Playa Vista, CA (US); Lawrence A RENNA, Huntington Beach, CA (US); Sean BARRETT, Redondo Beach, CA (US); John CHMIOLA, Scranton, PA (US)

(21) Appl. No.: 16/969,815

(22) PCT Filed: Feb. 13, 2019
(86) PCT No.: PCT/US2019/017901

§ 371 Date: Aug. 13, 2020

Related U.S. Application Data
(60) Provisional application No. 62/629,876, filed on Feb. 13, 2018.

(51) Int. Cl. H01M 4/04; H01M 10/0525

(52) U.S. Cl. CPC H01M 4/0404; H01M 2004/021; H01M 10/0525; H01M 4/0471

(57) ABSTRACT

A method of making three-dimensional solid-state electrodes includes the steps of: providing a slurry of one or more active materials, a pore former and/or a solvent, a binder, and a conductive additive; casting the slurry to form a three-dimensional film; and drying, and removing the pore former from, the three-dimensional film to produce a three-dimensional structure characterized by a substantial number of pores having low tortuosity and having their longitudinal axes extend in substantially the same direction between upper and lower surfaces of the film.

### CROSS-REFERENCE TO RELATED APPLICATIONS

This application claims the benefit of priority from U.S. Provisional Application Ser. No. 62/629,876 filed 13 Feb. 2018, the disclosure of which is incorporated herein by reference in its entirety.

### FIELD OF THE INVENTION

The present invention relates to the manufacture of electrodes and electrolytes and, more specifically, to manufacturing methods for making thick electrodes and electrolytes with uniaxially oriented pores characterized by low tortuosity.

### BACKGROUND

Typical lithium ion battery electrodes are limited in thickness by the ionic diffusion processes that take place during the cell charge and discharge. Thick electrodes are desirable because they result in higher energy density cells, lesser number of electrodes per cells and lower manufacturing costs. However, thick electrodes manufactured with traditional particulate slurry coating methods result in high resistance, limiting the amount of power that the battery can output they also pose an utilization problem wherein material beyond a 50 um thickness cannot be electrochemically exploited and hence constitute a dead weight in the cell architecture. More specifically, electrodes made with traditional particulate slurry coating methods present randomly distributed porosity and high tortuosity (tortuous paths for the liquid electrolyte to penetrate within the electrodes), because of the way they are manufactured with particles that are randomly distributed during the process of coating, and sometimes closed porosity that is not accessible to the electrolyte.

In order to design more powerful cells and lower the manufacturing costs by optimizing the amount of electrodes and dead components required in the cell construction, manufacturers currently have to design thin electrodes, limiting the coating thickness to below 100 um and typically around 40 um, trading off energy for power. There is thus a need for thicker electrodes which address the problem of high resistance to electrolyte penetration and that opens up the design space of cell engineering removing the boundaries of traditional manufacturing and allowing for a more optimized system that can leverage all the active materials effectively.

### SUMMARY OF THE DISCLOSURE

There is disclosed a method of making three-dimensional electrodes, comprising the steps of: providing a slurry of one or more active materials, a pore former and/or a solvent, a binder, and a conductive additive; casting the slurry to form a three-dimensional film; and drying, and removing the pore former from, the three-dimensional film to produce a three-dimensional structure characterized by a substantial number of pores having low tortuosity and having their longitudinal axes extend in substantially the same direction between upper and lower surfaces of the film.

Per one feature, the method comprises the further step of infiltrating the pores of the three-dimensional structure with one or more components selected from a liquid electrolyte, an anode active material, a cathode active material, a solid electrolyte, and a conductive additive.

According to another feature, the three-dimensional structure is characterized by a thickness of no less than about 50 μm and no greater than about 500 μm, typically of no less than about 300 μm and no greater than about 500 μm.

Per another feature, the pores have an internal diameter greater than about 1 μm and less than about 50 μm, and typically greater than about 10 μm and less than about 50 μm.

According to a still further feature, the pores have an acicular or elliptical structure with a long axis of 10 μm-1,000 μm and a short axis of 1 μm-20 μm.

Per a further feature, the step of casting the slurry comprises casting the slurry directly onto a current collector.

In one form, the method comprises the further step of laminating the three-dimensional structure to a current collector.

In one form, the step of casting the slurry is one of freeze-tape casting, freeze casting, tape casting, or casting, and wherein the active materials comprise a ceramic powder selected from the group of NCA, NMC, LFP, LNMO, Lithium rich NMC, Nickel rich NMC, LTO, graphite, conductive carbons, LLZO, perovskites, oxides, sulfides, polymers, NASICON structures, and garnets. The ceramic powder may comprise, per one form, nanoparticles which are made by one or more of liquid feed flame spray pyrolysis, co-precipitation, sol gel synthesis, ball milling, fluidized bed reaction, and cyclone flow particle scission. In one aspect of the invention, the nanoparticles are each less than about 1 μmin diameter, while in another aspect the nanoparticles are each about 400 nm in diameter.

According to one form, the method comprises the step of stacking a plurality of the three-dimensional structures with organic and/or inorganic binders, de-bindering by heating to decomposition temperatures of the binders, and then sintering the stacked three-dimensional structures to form a porous battery cell component characterized by low tortuosity.

Per still another aspect of the invention, the method comprises the step of cutting each of a plurality of the three-dimensional structures into a predetermined shape and size, and laminating said plurality of three-dimensional structures together to make a component of a battery cell.

According to a further feature, the step of coating the three-dimensional film by one or more of bar coating, wire wound rod coating, drop casting, freeze tape casting, freeze casting, casting, spin casting, doctor blading, dip coating, spray coating, microgravure, screen printing, ink jet printing, 3D printing, slot die casting, reverse comma casting, acoustic sonocasting, acoustic field patterning, magnetic field patterning, electric field patterning, photolithography, etching, and self-assembly.

Per another feature of the invention, the slurry suspension has a nano-powder concentration of greater than or equal to about 1 vol. % to less than or equal to about 70 vol %.

According to a further aspect, the slurry comprises the one or more active materials, the pore former and/or the solvent, the binder, the conductive additive active material, the binder, as well as a surfactant, and a thickener, with total solids loadings of greater than about 5% and less than about 70%, and more typically the total solids loadings are from about 20% to about 40%.

According to one aspect, the nano-powder active material particles are selected from but not limited to the group consisting of oxides, carbonates, carbides, nitrides, oxycarbides, oxynitrides, oxysulfides, metals, carbon, graphite, graphene, metal organic compounds, phosphides, polymers, metalorganic compounds, block co-polymers, biomaterials, salts, diamond-like carbon, borides, diamond, nano-diamond, silicides, silicates or combinations thereof.

Per a still further feature, the solvent component comprises one or more of water, methanol, ethanol, propanol, butanol, xylene, hexane, methyl ethyl ketone, acetone, toluene, water, camphene, tert-butyl alcohol, acetic acid, benzoic acid, camphene, cyclohexane, dioxane, dimethyl sulfoxide, dimethylformamide, ethylene glycol, ionic liquids, glycerin ether, hydrogen peroxide, and naphthalene, and combinations thereof.

In some embodiments of the invention, the pore former is the solvent.

According to some embodiments, the pore former is an aqueous solvent that is frozen and sublimed away while still in the frozen state to produce the three-dimensional structure characterized by a substantial number of pores having low tortuosity and having their longitudinal axes extend in substantially the same direction between upper and lower surfaces of the film.

In some embodiments, the slurry comprises ceramic particles, water, an alkylphenolethoxylates binder, a cellulose-based thickener, and a polyacrylic acid binder, and the method comprises the step of sintering the film at 775° C. to remove the binders.

Per another feature, the slurry comprises one or more dispersants selected from the group consisting of poloxamers, fluorocarbons, alkylphenol ethoxylates, polyglycerol alkyl ethers, glucosyl dialkyl-ethers, crown ethers, polyoxyethylene alkyl ethers, Brij, sorbitan esters, Tweens, polyacrylic acid, bicine, citric acid, steric acid, fish oil, phenyl phosphonic acid, sulphates, sulfinates, sulfonates, phosphoric acid, ammonium polymethacrylate, alkyl ammoniums, phosphate esters, ionic liquids, molten salts, glycols, polyacrylates, amphiphilic molecules, organosilanes, and combinations thereof.

According to yet another feature, the binder is selected from the group consisting of polyvinyl butyral, aromatic compounds, acrylics, acrylates, fluorinated polymers, styrene-butadiene rubber, hydrocarbon chain polymers, silicones, polyvinyl acetate, polytetrafluoroethylene, acrylonitrile butadiene styrene, methyl cellulose, ethyl cellulose, carboxymethyl cellulose, polyacrylate esters, polyurethane, polyethylene glycol, acrylic compounds, polystyrene, polyvinyl alcohol, polymethylmethacrylate, poly-butyl-methacrylate, poly-vinyl-fluoride, polyethylene oxide, poly(2-ethyl-2-oxazoline), and combinations thereof.

In another aspect of the invention, the slurry comprises a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

According to a further feature, the slurry may be an acetone-based slurry including the conductive additive, an electrode active material, and a Phthalate plasticizer as the pore former, and wherein the step of removing the pore former comprises soaking the dried film in a solvent.

Per a further feature, the slurry may comprise a thickener selected from the group consisting of Xanthan gum, cellulose, carboxymethylcellulose, tapioca, algenate, chia seeds, guar gum, gelatin, cellulose, carrageenan, polysaccharides, galactomanannan, glucomannan, glycols, acrylate cross polymer, and combinations thereof.

Batteries constructed from one or more three-dimensional structure made according to the method of the present invention are, in one aspect, characterized by a gravimetric energy density of 50-500 Wh/kg and a power density between 300-1000 W/kg. In another aspect, they are characterized by a volumetric energy density of 50-1200 Wh/L and a power density between 500-3000 W/L.

### BRIEF DESCRIPTION OF THE DRAWINGS

Embodiments will now be described, by way of example only, with reference to the accompanying drawings, wherein:

FIG. 1 is a graphical depiction of an electrode with unidirectionally aligned pores and low tortuosity;

FIG. 2 represents an electrode with unidirectionally aligned pores and low tortuosity;

FIG. 3 is an SEM image of a freeze tape casted NMC;

generally depicts the freeze casting steps of the present invention;

FIG. 4 is SEM fracture surface images of (a) porous/dense LLZO bilayer in which the dense layer was form by aerosol spray method and (b) porous/dense ZrO₂ bilayer formed by applying ZrO₂ slurry on pore plugged ZrO₂ scaffold;

FIG. 5 is data for freeze tape cast Lithium Lanthanum Zirconium Oxide reconstructed X-Ray Microtomography using the synchrotron at Lawrence Berkeley National Laboratory;

FIG. 6 graphically depicts the relationship between % porosity and % volume fraction for a variety of prior art solvents and solids in electrochemical cells;

FIG. 7 is a graphical depiction of a typical freeze tape casting instrument;

FIG. 8 generally depicts the freeze casting steps of the present invention;

FIG. 9 shows the water triple point in connection with Example 9.

### DETAILED DESCRIPTION

Broadly speaking, the present invention comprehends methods of making three-dimensional structured electrodes, comprising the steps of: providing a slurry of one or more active materials, a pore former and/or a solvent, a binder, and a conductive additive; casting the slurry to form a three-dimensional film; and drying, and removing the pore former from, the three-dimensional film to produce a three-dimensional structure characterized by a substantial number of pores having low tortuosity and having their longitudinal axes extend in substantially the same direction between upper and lower surfaces of the film.

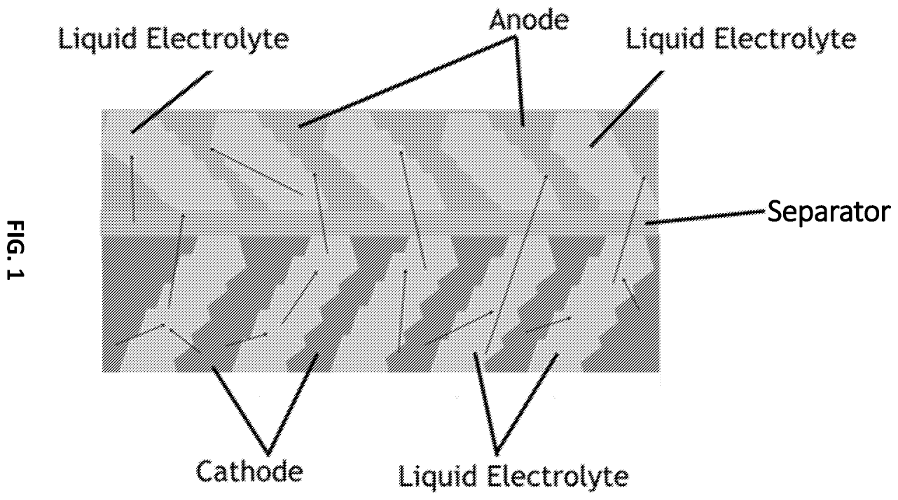

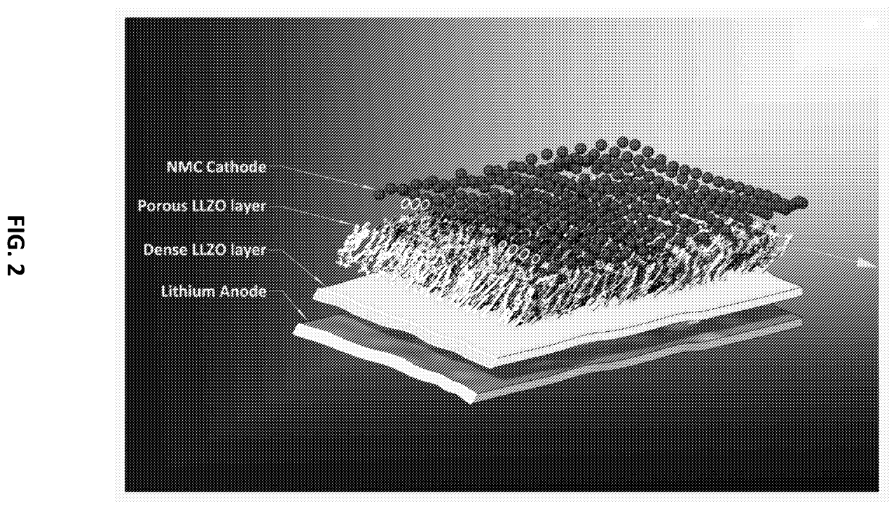

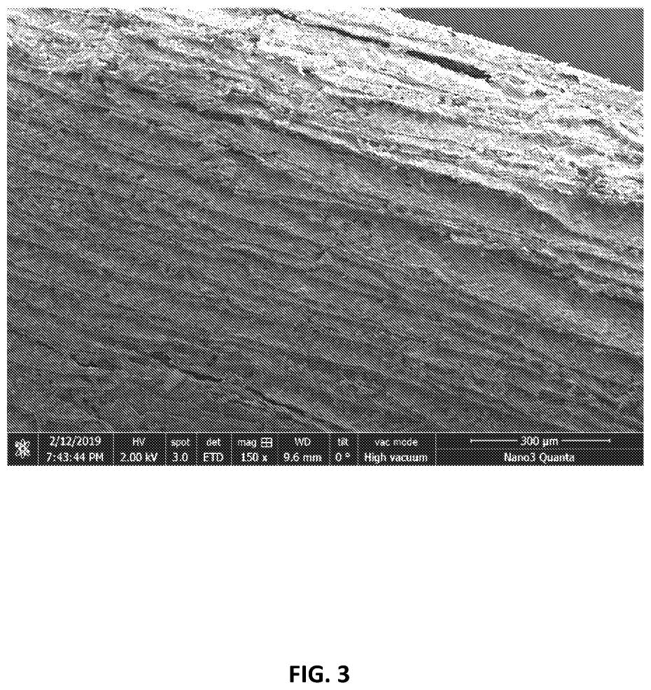

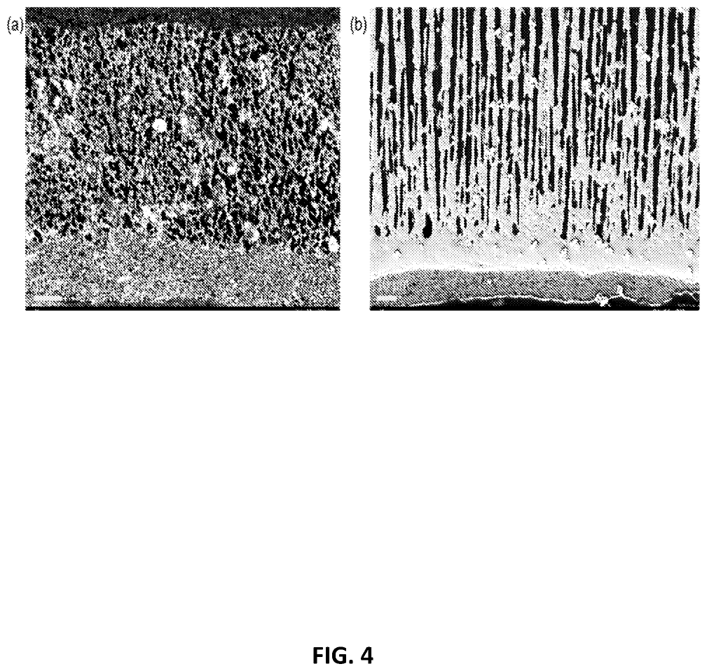

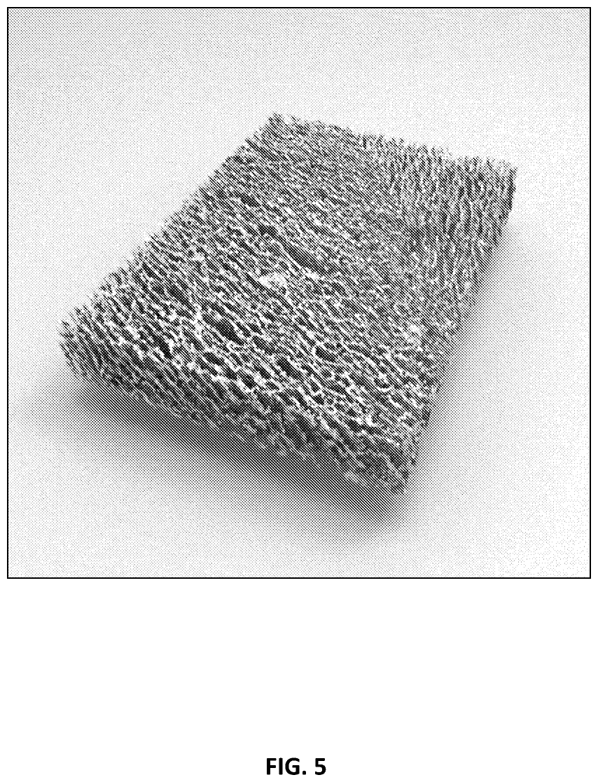

Referring to FIGS. 1 through 5, the resulting electrodes present a substantial number of pores of desirable size to host the liquid electrolyte. The pores are also characterized by low tortuosity; i.e., the ionic movement within the pores and the electrolyte wetting of the pores is very facile because the inside of the pores are characterized by the absence of curvatures in excess of 180 degrees. Thus, “low tortuosity” as used herein means and refers to pores the interior, longitudinal passages of which are characterized by the absence of curvatures in excess of 180 degrees.

A substantial number of the pores are also oriented uniaxially; i.e., a substantial number of the pores are characterized in that their longitudinal axes extend in substantially the same direction between the upper and lower surfaces of the film.

The pores have an internal diameter greater than about 1 μm and less than about 50 μm, and in exemplary embodiment greater than about 10 μm and less than about 50 μm.

The prior art teaches pore forming using sacrificial pore formers that produce randomly oriented porosity, such as in G. T. Hitz, et. al, “High-rate lithium cycling in a scalable trilayer Li-garnet-electrolyte architecture” Materials Today (2019) 22: 50-57. In contrast, the present invention teaches against methods that produce non-unidirectional (i.e., randomly oriented) pores because of limitations in loading the cathode, and the inability to produce a greater than 90% porous structure, which defeats the advantage of using a scaffold.

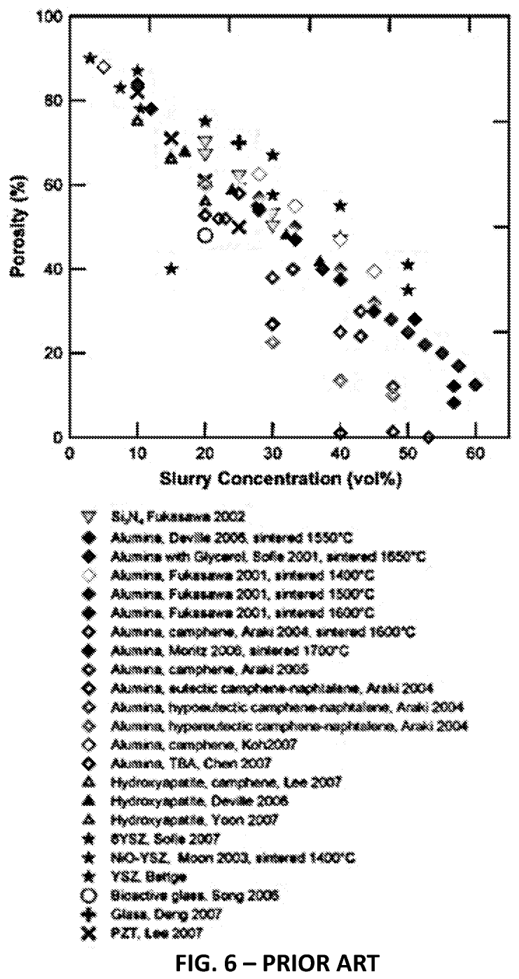

The prior art also teaches that, for cast films, % porosity decreases generally linearly with an increase in (vol %) slurry concentration for various materials. See FIG. 6.

The three-dimensional films of the present invention are characterized by a thickness of no less than about 50 μm and no greater than about 500 μm and, in some embodiments, thicknesses of no less than about 200 μm and no greater than about 500 μm.

The slurry comprises an electrode active material, a surfactant, a thickener, a binder, with total solids loadings of greater than about 5% and less than about 70%, and more typically of from about 20% to about 40%.

Exemplary electrode active materials include a ceramic powder selected from the group of NCA, NMC, LFP, LNMO, lithium rich NMC, nickel rich NMC, LTO, graphite, conductive carbons, LLZO, perovskite, oxides, sulfides, polymers, NAS ICON, and garnet. The ceramic powder is in the form of nanoparticles which are made by one or more of liquid feed flame spray pyrolysis, co-precipitation, sol gel synthesis, ball milling, fluidized bed reaction, and cyclone flow particle scission. In exemplary embodiments, the nanoparticles are each less than about 1 μm in diameter are each about 400 n min diameter.

The slurry suspension has a nano-powder concentration of greater than or equal to about 1 vol. % to less than or equal to about 70 vol %.

The nano-powder active material particles are selected from but not limited to the group consisting of oxides, carbonates, carbides, nitrides, oxycarbides, oxynitrides, oxysulfides, metals, carbon, graphite, graphene, metal organic compounds, phosphides, polymers, metalorganic compounds, block co-polymers, biomaterials, salts, diamond-like carbon, borides, diamond, nano-diamond, silicides, silicates or combinations thereof.

The slurry also comprises one or more dispersants selected from the group consisting of poloxamers, fluorocarbons, alkylphenol ethoxylates, polyglycerol alkyl ethers, glucosyl dialkyl-ethers, crown ethers, polyoxyethylene alkyl ethers, Brij, sorbitan esters, Tweens, polyacrylic acid, bicine, citric acid, steric acid, fish oil, phenyl phosphonic acid, sulphates, sulfinates, sulfonates, phosphoric acid, ammonium polymethacrylate, alkyl ammoniums, phosphate esters, ionic liquids, molten salts, glycols, polyacrylates, amphiphilic molecules, organosilanes, and combinations thereof.

The slurry includes a binder selected from the group consisting of polyvinyl butyral, aromatic compounds, acrylics, acrylates, fluorinated polymers, styrene-butadiene rubber, hydrocarbon chain polymers, silicones, polyvinyl acetate, polytetrafluoroethylene, acrylonitrile butadiene styrene, methyl cellulose, ethyl cellulose, carboxymethyl cellulose, polyacrylate esters, polyurethane, polyethylene glycol, acrylic compounds, polystyrene, polyvinyl alcohol, polymethylmethacrylate, poly-butyl-methacrylate, poly-vinyl-fluoride, polyethylene oxide, poly(2-ethyl-2-oxazoline), and combinations thereof.

The slurry also includes a thickener selected from the group consisting of Xanthan gum, cellulose, carboxymethylcellulose, tapioca, algenate, chia seeds, guar gum, gelatin, cellulose, carrageenan, polysaccharides, galactomanannan, glucomannan, glycols, acrylate cross polymer, and combinations thereof.

The secondary components may include solvents, organics, pore-forming agents, metals, ceramics, gasses, and/or glasses, viruses, as described below.

The solvent component comprises one or more of water, methanol, ethanol, propanol, butanol, xylene, hexane, methyl ethyl ketone, acetone, toluene, water, camphene, tert-butyl alcohol, acetic acid, benzoic acid, camphene, cyclohexane, dioxane, dimethyl sulfoxide, dimethylformamide, ethylene glycol, ionic liquids, glycerin ether, hydrogen peroxide, and naphthalene, and combinations thereof.

The slurry also includes a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

The methods of the present invention may be performed using casting, freeze-tape casting, freeze casting, or tape casting. The secondary components may be removed by various means, including, for instance, by sublimation or sintering.

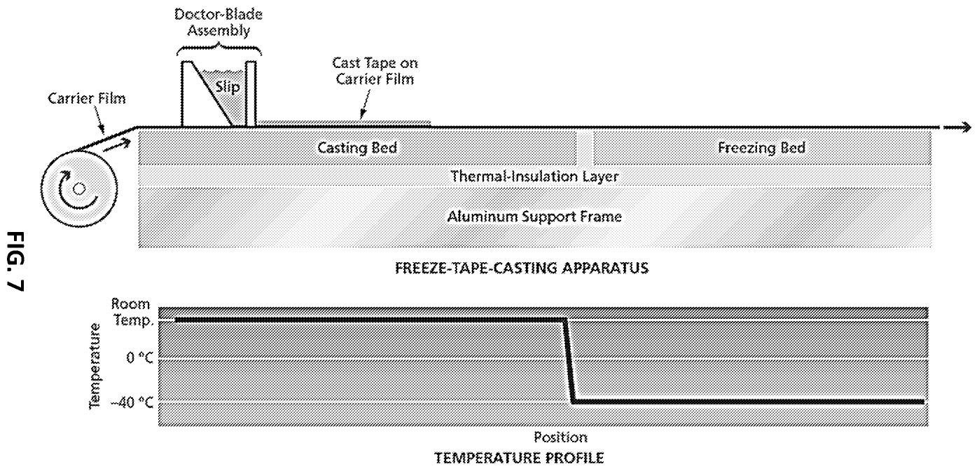

FIG. 7 schematically depicts an exemplary freeze-casting assembly for carrying out the method of the present invention, according to one embodiment thereof. As shown, a source of slurry, or slip, is continuously cast on the surface of a carrier film, using a doctor-blade assembly. The cast tape/carrier film moves onto a freezing bed for solidification. Initial casting takes place at room temperature, while the freezing takes place at −40° C.

A preferred embodiment of the present invention comprises using a casting bed freezing temperature of below zero degrees Celsius, and typically between 0° C. and −170° C., and a speed of casting between 0.5 mm/min and 50 mm/min. The optimum temperature and speed is for the process to allow ice crystal to be uniformly nucleated and grow with a uniform size and distribution throughout the cast tape. As a result of such porous microstructure, the ions can travel faster than in conventional lithium ion batteries (as shown graphically in FIG. 1 by the black arrows), allowing for extremely high power capabilities. Also as a result, the cells built with this electrode microstructure can be charged at much higher rates than conventional cells; e.g., instead of needing 30-45 minutes to fully charge a battery from 0% to 80% State of Charge (SOC), the batteries of the present invention can be charged to 80% SOC in 1-10 minutes.

The three-dimensional unsintered films containing binder may further be stacked, have the binder removed through an appropriate heat treatment process, and be sintered to form a porous electrode with low tortuosity.

In the formation of batteries, the methods of the present invention include the steps of casting the slurry directly onto a current collector or laminating the three-dimensional electrode structure to a current collector, and infiltrating the pores of the dried three-dimensional film with one or more components selected from a liquid electrolyte, an anode active material, a cathode active material, a solid electrolyte, and a conductive additive.

In some embodiments, the three-dimensional films are removed from the substrate after drying and before sintering, then cut into predetermined shapes and sizes which are laminated together to make a component of a battery cell.

The methods of the present invention also includes, in some embodiments, the step of coating the three-dimensional films by one or more of bar coating, wire wound rod coating, drop casting, freeze tape casting (see FIG. 7), freeze casting, casting, spin casting, doctor blading, dip coating, spray coating, microgravure, screen printing, ink jet printing, 3D printing, slot die casting, reverse comma casting, acoustic sonocasting, acoustic field patterning, magnetic field patterning, electric field patterning, photolithography, etching, and/or self-assembly.

The percent (%) porosity, pore size, and orientation of the pores is controlled by: 1) slurry formulation, solvent, and solids content; 2) casting temperature; and 3) speed of casting.

Electrodes of multiple electro-chemistries can be manufactured using this technique; e.g., lithium-ion, sodium-Ion, magnesium-ion, lithium-sulfur, zinc-air, silver-zinc, nickel-zinc, and lead acid.

The following examples describe various embodiments of the method of the invention.

### Example 1

In one embodiment of the present invention, the three-dimensional porous structure used as an electrode scaffold is made from a poly-methyl-methacrylate (PMMA) polymer. The PMMA is formed as a negative template having uniaxially oriented features that are used as pore formers. More specifically, the PMMA is dissolved in a mixture of ethanol and water. The PMMA solution is then freeze tape casted, the freezing solvent crystals expel the PMMA, and then the solvent is sublimed. This creates a porous PMMA structure with low tortuosity pores.

Next, a slurry containing 60% LLZO and 40% water, a dispersant, and a binder is infiltrated into the porous PMMA scaffold.

The PMMA as a pore former, and the other organic material from the LLZO slurry, is then burned out, and the LLZO particles are sintered together by heating to 1050° C. This creates a LLZO porous scaffold with low tortuosity pores.

An active material slurry made of 94% wt. lithium nickel manganese cobalt oxide (NMC) cathode and 3% binder, and 3% conductive additive is infiltrated into the LLZO scaffold.

After the cast film is dried and the solvents are removed. As a result, a fully porous cathode electrode is obtained wherein the porosity is greater than 40% and the pores are uniaxially oriented.

### Example 2

In another embodiment, a porous structure is formed by freeze-tape casting a slurry wherein the pore former is an aqueous solvent, such as water, that is frozen and sublimed away while still in the frozen state, leaving behind a uniaxially oriented pore structure with low tortuosity.

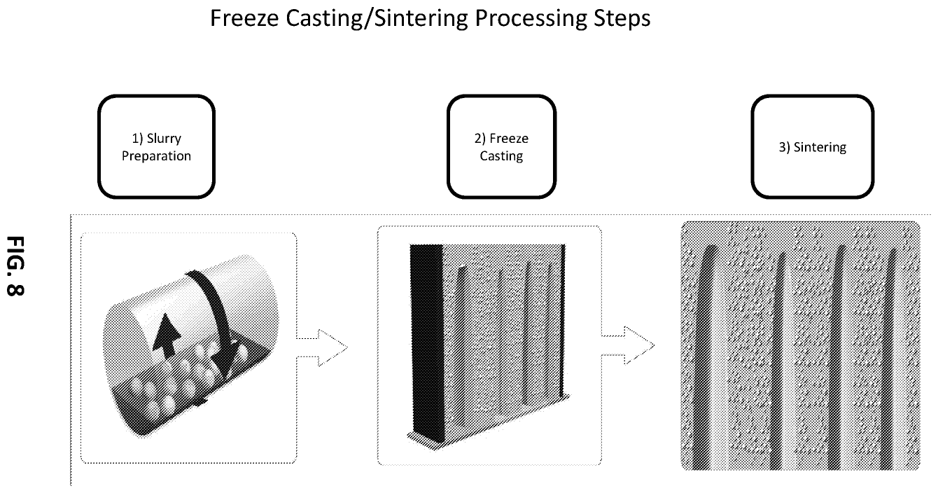

The aqueous slurry is made of 15% ceramic particles, for example NMC 622 (BASF), and the residual 85% comprises water, an alkylphenolethoxylates binder, cellulose-based thickener, and a polyacrylic acid binder that hold together the porous structure until it is processed through a sintering step wherein all binders and organic materials are removed at 775° C. and only a dense porous structure is left behind with good sintering of the NMC. See FIG. 8.

### Example 3

In another embodiment, the pore former is a solvent selected from the t-Butanol family, that is frozen and sublimed.

The t-Butanol slurry is made of 15% ceramic particles, for example Li₇La₃Zn₂O₁₂ (LLZO), and the residual 85% comprises t-Butanol, a dispersant, a thickener, and binder elements that hold together the porous structure until it is processed through a sintering step wherein all binders and organic materials are removed, leaving behind only a dense porous structure.

An active material slurry made of 30% NMC and 70% water, a plasticizer, a dispersant, and a binder is then cast into the ceramic template.

### Example 4

In another embodiment, the pore former is a virus selected from the family of tobacco mosaic viruses (TMV). A low tortuosity scaffold is created by the self-assembly of the TMV protein, which forms a hierarchical structure of columnar disks.

An active material slurry made of 5% ceramic particles, for instance LLZO, and the residual 85% comprises a solvent cast into the TMV protein self-assembled structure.

In a subsequent sintering step, all virus/protein materials, binders, and organic materials are removed, leaving behind a dense porous structure.

An electrode active material slurry made of 30% NMC and 70% water, a plasticizer, a dispersant, and a binder is cast into the ceramic template.

### Example 5

In another embodiment, the pore former is a Phthalate plasticizer, for instance dibutyl phthalate (DBP), which is dispersed into an acetone-based slurry containing a binder, an electrode active material, and conductive additive. The slurry containing 20 wt. % DBP, 60 wt. % electrode active material, 15 wt. % PVDF-HFP (KYNAR 2801) and 5 wt. % Super P carbon black (TIMCAL, Bodio, Switzerland), and a controlled amount of acetone (typically, 5-10 mL) is stirred for 4 hours and then cast in a thin layer onto a flat surface using doctor blading technique. The so-called plastic film is allowed to dry and the DBP is then removed by soaking the filmin a diethyl ether solvent to dissolve the DBP, creating porosity in the film. The soaking process is repeated three times to ensure complete DBP removal.

### Example 6

In another embodiment, the pore former is an oxide selected from the family of silicon oxide. The pore former is removed by reaction with HF. For example, nano- or microparticles of SiO₂ are dispersed into a water-based slurry containing a dispersant and a polymer binder. The slurry containing the SiO₂ particles is then freeze-tape casted to form a porous, uniaxially oriented structure with low tortuosity.

The carbon-based materials (i.e., the binder and dispersant) can be removed via pyrolization.

An active material slurry made of 30% NMC and 70% water, a plasticizer, a dispersant, and a binder is cast into the SiO₂ template. HF can be used to remove the SiO₂ scaffold, yielding an electrode with porous microstructure and low tortuosity pores for high energy density batteries.

### Example 7

In another embodiment, the pore former is a metal with low melting point, such as zinc, that can be removed through moderate temperature, low-pressure sublimation. In this example, NMC is dispersed in molten zinc, and freeze casted to form a solid zinc structure, which pushes the NMC into a columnar morphology. The zinc can then be sublimed in vaccuo at 550° C. to leave behind a porous, low tortuosity NMC cathode.

### Example 8

In one embodiment, the scaffold is electrochemically active and conductive, and is infiltrated with an electrolyte.

The freeze tape-cast electrodes can be made from slurries containing active material powders (91 wt %), Super-C65 carbon black powder (5 wt %, IMERYS), carboxymethyl cellulose powder (CMC, 2 wt %), and a styrene-butadiene rubber aqueous emulsion containing 50 wt % solids in water (SBR, 14 wt %, MTI CORPORATION, EQLib-SBR).

In a representative preparation, approximately 20.33 g of CMC powder is added to approximately 980.95 g of water with continuous stirring using an impeller blade at 300 rpms for 10 minutes until the CMC is partially dissolved. Then the slurry is transferred and mixed in a double planetary mixer overnight until the CMC is completely dissolved.

Then, approximately 1.85 g of the SBR emulsion is added with 92.5 g of the CMC 2% water solution (1.85 g of CMC) stirring. Approximately 84 g of active material (graphite) and 4.62 g of carbon black powder is thoroughly mixed and then slowly added with continuous stirring to the vessel containing the dissolved binders in water, followed by stirring. The resulting slurry has approximately 55 wt % solids.

Upon water removal, the resulting solid electrode has the following composition: 91.0 wt % active material; 5.0 wt % carbon black; 2.0 wt % CMC; and 2.0 wt % SBR.

Once the slurry is ready, it is coated onto a piece of battery-grade copper foil (MTI CORPORATION −11 μm thick coated with conductive carbon) using a dispenser, followed by freeze tape casting using the doctor blade adjusted to the desired liquid film thickness. The front edge of the tape is moved over the cold front (already set at the desired temperature), and it is slowly pulled over the frozen bed at a constant speed of 4 mm s⁻¹. Frozen tapes are immediately freeze dried for 3 h at a temperature of −20° C. and a pressure 0.03 mbar.

### Example 9

In another embodiment, the scaffold is electrochemically inert but electrically conductive, and is infiltrated with both electrolyte and active materials.

The freeze tape-cast electrically conductive matrix can be made from slurries containing Super-C65 carbon black powder (70 wt %, IMERYS), carboxymethyl cellulose powder (CMC, 3 wt %), and a styrene-butadiene rubber aqueous emulsion containing 50 wt % solids in water (SBR, 27 wt %, MTI CORPORATION, EQLib-SBR).

In a representative preparation, approximately 30.5 g of CMC powder is added to approximately 980.95 g of water with continuous stirring using an impeller blade at 300 rpms for 10 minutes until the CMC is partially dissolved. Then the slurry is transferred and mixed in a double planetary mixer overnight until the CMC is completely dissolved. Then, 8.49 g of the SBR emulsion is added with 92.5 g of the CMC 3% water solution while stirring.

8 g of Super P powder was thoroughly mixed and ground, then slowly added with continuous stirring to the vessel containing the dissolved binders in water, followed by stirring overnight. Upon water removal, the resulting solid electrode has the following composition: 70.0 wt % Super P; 3 wt % CMC; and 27 wt % SBR. Once the slurry is ready, it is coated onto a piece of battery-grade Aluminum foil (MTI CORPORATION −18 μm thick coated with conductive carbon) using a dispenser, followed by tape casting using the doctor blade adjusted to the desired liquid film thickness. Normal tape-cast samples were dried in ambient atmosphere.

In the case of freeze-tape casting, without any delay one edge of the tape is placed over the freezing front already set at the desired temperature of −130° C., −150° C., or −170° C., and then slowly pulled over the freeze bed at a constant speed of 3.7 mm s⁻¹. Frozen tapes were immediately freeze dried for 3 hours at a temperature of −20° C. and pressure 0.03 mbar.

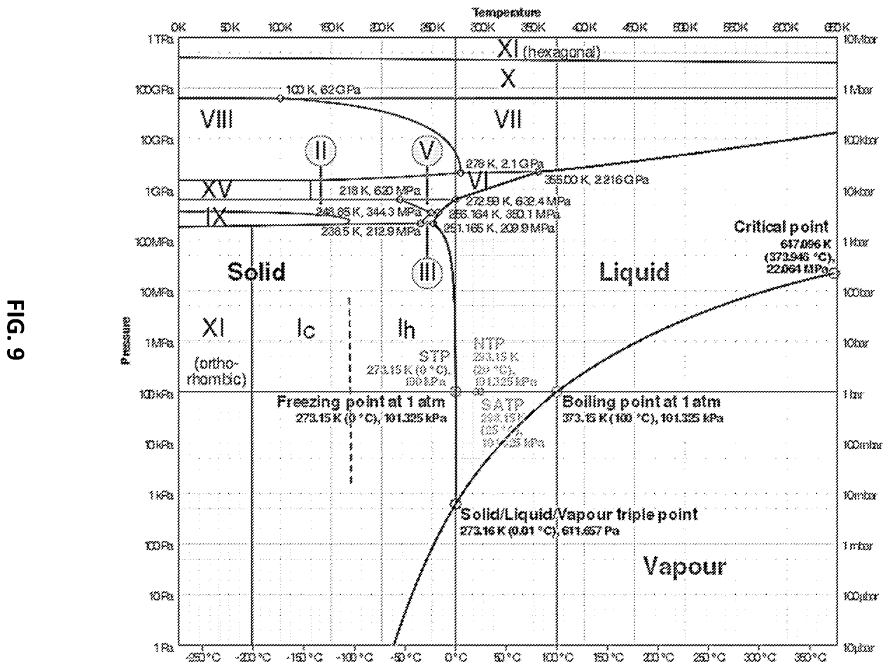

Following sublimation at −20° C. and 5 mTorr, a point below the water triple point in FIG. 9, the scaffold was infiltrated with a cathode slurry consisting of 92 wt. % Al₂O₃-doped NMC811 (BASF), 3.5 wt. % PVDF (SOLVEY, SOLF 3510), 2.5 wt. % conductive carbon (Super-C65, IMERYS), and dispersed into N-Methyl-2-pyrrolidone (NMP) for a total solids loading of 33.4%. The cathode slurry was then infiltrated into the conductive carbon scaffold using vacuum pore filling producing a functional thick cathode of −325 μm and having superior performance to standard-processed cathodes.

The present invention addresses multiple problems associated with prior-art lithium ion batteries, including: The low energy-density of lithium ion cells; the low power performance of cells with energy density above 230 Wh/kg; the high internal resistance of high energy density cells, e.g. above 230 Wh/kg; the low power performance of lithium ion cells at low temperatures; the high cost of lithium ion cells; the need for low viscosity, large volumes and high cost liquid electrolytes to build practical cells; and the high flammability of lithium ion cells due to electrolyte formulations.

The present invention represents a transformational approach to battery electrode and cell manufacturing, allowing for facile and low cost manufacturing of thick electrodes and cells with both high energy density and high power capabilities. More particularly, the present invention comprises a casting technique used to manufacture both anode and cathode electrodes with thicknesses above 100 um and exhibiting low tortuosity. By means of casting, electrodes can be manufactured with controlled porosity and unidirectionally aligned pores having low tortuosity.

The benefits of low tortuosity electrodes are remarkable and affect both the cell and battery level performance: As noted, cells can be built with thick electrodes, e.g. above 100 μm and typically around 400-500 μm without increasing the internal resistance; resulting cell energy density can be increased by as much as 40-50%; resulting cell power density can be increased by 40-50%; resulting cell internal resistance can be decreased by 50-60%; electrolytes with higher viscosity and higher lithium salt concentration can be deployed, increasing the power performance and the energy density of the cell (such high viscosity/high salt concentration electrolytes have better performance in cold temperatures presenting advantages for certain applications (e.g., automotive)); liquid electrolyte amounts can be decreased by 60-70% (electrolyte “starved” cells are less flammable and present an increase in safety of both cell and battery level, and are cheaper as the liquid electrolyte is one of the most costly cell component, representing typically 25% of the bill of materials cost).

Although exemplary embodiments of the present invention have been described and illustrated, it will be apparent to those skilled in the art that numerous modifications and variations can be made thereto without departing from the scope of the invention as defined in the appended claims.

The invention in which an exclusive property or privilege is claimed is defined as follows:

1. A method of making three-dimensional electrodes and/or electrolytes, comprising the steps of:
providing a slurry of one or more active materials, a pore former and/or a solvent, a binder, and a conductive additive;
casting the slurry to form a three-dimensional film; and
drying, and removing the pore former from, the three-dimensional film to produce a three-dimensional structure characterized by a substantial number of pores having low tortuosity and having their longitudinal axes extend in substantially the same direction between upper and lower surfaces of the film.

2. The method of claim 1, comprising the further step of infiltrating the pores of the three-dimensional structure with one or more components selected from a liquid electrolyte, an anode active material, a cathode active material, a solid electrolyte, and a conductive additive.

3. The method of claim 1, wherein the three-dimensional structure is characterized by a thickness of no less than about 50 μm and no greater than about 500 μm.

4. The method of claim 2, wherein the three-dimensional structure is characterized by a thickness of no less than about 300 μm and no greater than about 500 μm.

5. The method of claim 1, wherein the pores have an internal diameter greater than about 1 μm and less than about 50 μm.

6. The method of claim 5, wherein the pores have an internal diameter greater than about 10 μm and less than about 50 μm.

7. The method of claim 1, wherein the pores have an acicular or elliptical structure with a long axis of 10 μm-1,000 μm and a short axis of 1 μm-20 μm.

8. The method of claim 1, wherein the step of casting the slurry comprises casting the slurry directly onto a current collector.

9. The method of claim 1, comprising the further step of laminating the three-dimensional structure to a current collector.

10. The method of claim 1, wherein the step of casting the slurry is one of freeze-tape casting, freeze casting, tape casting, or casting, and wherein the active materials comprise a ceramic powder selected from the group of NCA, NMC, LFP, LNMO, Lithium rich NMC, Nickel rich NMC, LTO, graphite, conductive carbons, LLZO, perovskites, oxides, sulfides, polymers, NASICON structures, and garnets.

11. The method of claim 10, wherein the ceramic powder comprises nanoparticles which are made by one or more of liquid feed flame spray pyrolysis, co-precipitation, sol gel synthesis, ball milling, fluidized bed reaction, and cyclone flow particle scission.

12. The method of claim 11, wherein the nanoparticles are each less than about 1 μm in diameter.

13. The method of claim 12, wherein the nanoparticles are each about 400 nmin diameter.

14. The method of claim 1, further comprising the step of stacking a plurality of the three-dimensional structures with organic and/or inorganic binders, de-bindering by heating to decomposition temperatures of the binders, and then sintering the stacked three-dimensional structures to form a porous battery cell component characterized by low tortuosity.

15. The method of claim 1, further comprising the step cutting each of a plurality of the three-dimensional structures into a predetermined shape and size, and laminating said plurality of three-dimensional structures together to make a component of a battery cell.

16. The method of claim 1, further comprising the step of coating the three-dimensional film by one or more of bar coating, wire wound rod coating, drop casting, freeze tape casting, freeze casting, casting, spin casting, doctor blading, dip coating, spray coating, microgravure, screen printing, ink jet printing, 3D printing, slot die casting, reverse comma casting, acoustic sonocasting, acoustic field patterning, magnetic field patterning, electric field patterning, photolithography, etching, and self-assembly.

17. The method of claim 1, wherein the slurry suspension has a nano-powder concentration of greater than or equal to about 1 vol. % to less than or equal to about 70 vol %.

18. The method of claim 1, wherein the slurry comprises the one or more active materials, the pore former and/or the solvent, the binder, the conductive additive active material, the binder, as well as a surfactant, and a thickener, with total solids loadings of greater than about 5% and less than about 70%

19. The method of claim 18, wherein the total solids loadings are from about 20% to about 40%.

20. The method of claim 1, wherein the nano-powder active material particles are selected from but not limited to the group consisting of oxides, carbonates, carbides, nitrides, oxycarbides, oxynitrides, oxysulfides, metals, carbon, graphite, graphene, metal organic compounds, phosphides, polymers, metalorganic compounds, block co-polymers, biomaterials, salts, diamond-like carbon, borides, diamond, nano-diamond, silicides, silicates or combinations thereof.

21. The method according to claim 1, wherein the solvent component comprises one or more of water, methanol, ethanol, propanol, butanol, xylene, hexane, methyl ethyl ketone, acetone, toluene, water, camphene, tert-butyl alcohol, acetic acid, benzoic acid, camphene, cyclohexane, dioxane, dimethyl sulfoxide, dimethylformamide, ethylene glycol, ionic liquids, glycerin ether, hydrogen peroxide, and naphthalene, and combinations thereof.

22. The method according to claim 21, wherein the pore former is the solvent.

23. The method of claim 22, wherein the pore former is an aqueous solvent that is frozen and sublimed away while still in the frozen state to produce the three-dimensional structure characterized by a substantial number of pores having low tortuosity and having their longitudinal axes extend in substantially the same direction between upper and lower surfaces of the film.

24. The method of claim 23, wherein the slurry comprises ceramic particles, water, an alkylphenolethoxylates binder, a cellulose-based thickener, and a polyacrylic acid binder, and wherein further the method comprises the step of sintering the film at 775° C. to remove the binders.

25. The method of claim 1, wherein the slurry comprises one or more dispersants selected from the group consisting of poloxamers, fluorocarbons, alkylphenol ethoxylates, polyglycerol alkyl ethers, glucosyl dialkyl-ethers, crown ethers, polyoxyethylene alkyl ethers, Brij, sorbitan esters, Tweens, polyacrylic acid, bicine, citric acid, steric acid, fish oil, phenyl phosphonic acid, sulphates, sulfinates, sulfonates, phosphoric acid, ammonium polymethacrylate, alkyl ammoniums, phosphate esters, ionic liquids, molten salts, glycols, polyacrylates, amphiphilic molecules, organosilanes, and combinations thereof.

26. The method of claim 1, wherein the binder is selected from the group consisting of polyvinyl butyral, aromatic compounds, acrylics, acrylates, fluorinated polymers, styrene-butadiene rubber, hydrocarbon chain polymers, silicones, polyvinyl acetate, polytetrafluoroethylene, acrylonitrile butadiene styrene, methyl cellulose, ethyl cellulose, carboxymethyl cellulose, polyacrylate esters, polyurethane, polyethylene glycol, acrylic compounds, polystyrene, polyvinyl alcohol, polymethylmethacrylate, poly-butyl-methacrylate, poly-vinyl-fluoride, polyethylene oxide, poly(2-ethyl-2-oxazoline), and combinations thereof.

27. The method of claim 1, wherein the slurry comprises a plasticizer selected from the group consisting of benzyl butyl phthalate, acetic acid alkyl esters, bis[2-(2-butoxyethoxy)ethyl] adipate, 1,2-Dibromo-4,5-bis(octyloxy)benzene, dibutyl adipate, dibutyl itaconate, dibutyl sebacate, dicyclohexyl phthalate, diethyl adipate, diethyl azelate, di(ethylene glycol) dibenzoiate, diethyl sebacate, diethyl succinate, diheptyl phthalate, diisobutyl adipate, diisobutyl fumarate, diisobutyl phthalate, diisodecyl adipate, diisononyl phthalate, dimethyl adipate, dimethyl azelate, dimethyl phthalate, dimethyl sebacate, dioctyl terephthalate, diphenyl phthalate, di(propylene glycol) dibenzoate, dipropyl phthalate, ethyl 4-acetylbutyrate, 2-(2-ethylhexyloxy)ethanol, isodecyl benzoate, isooctyl tallate, neopentyl glycol dimethylsulfate, 2-nitrophenyl octyl ether, poly(ethylene glycol) bis(2-ethylhexanoate), poly(ethylene glycol) dibenzoate, poly(ethylene glycol) dioleate, poly(ethylene glycol) monolaurate, poly(ethylene glycol) monooleate, poly(ethylene glycol) monooleate, sucrose benzoate, 2,2,4-trimethyl-1,3-pentanediol dibenzoate, trioctyl timelitate, and combinations thereof.

28. The method of claim 27, wherein the slurry is an acetone-based slurry including the conductive additive, an electrode active material, and a Phthalate plasticizer as the pore former, and wherein the step of removing the pore former comprises soaking the dried filmin a solvent.

29. The method of claim 1, wherein the slurry comprises a thickener selected from the group consisting of Xanthan gum, cellulose, carboxymethylcellulose, tapioca, algenate, chia seeds, guar gum, gelatin, cellulose, carrageenan, polysaccharides,
galactomanannan, glucomannan, glycols, acrylate cross polymer, and combinations thereof.

30. A battery constructed from one or more three-dimensional structure made according to the method of claim 1, the battery characterized by a gravimetric energy density of 50-500 Wh/kg and a power density between 300-1000 W/kg.

31. A battery constructed from one or more three-dimensional structures made according to the method of claim 1, the battery characterized by a volumetric energy density of 50-1200 Wh/L and a power density between 500-3000 W/L.
